(19) United States
(12) Patent Application Publication
(10) Pub. No.: US 2026/0132537 A1
(43) Pub. Date: May 14, 2026

(54) ELECTRODE SEPARATION METHOD AND SEPARATION SYSTEM

(71) Applicants: SK ON CO., LTD., Seoul (KR); INDUSTRY ACADEMY COOPERATION FOUNDATION OF SEJONG UNIVERSITY, Seoul (KR)

(72) Inventors: Chan Ho KIM, Daejeon (KR); Hyung Joo NOH, Daejeon (KR); Byoung Ki SON, Daejeon (KR); Kyung Jung KWON, Seoul (KR); Gi Gap HAN, Seoul (KR); Hui Su JEONG, Seoul (KR)

(21) Appl. No.: 19/380,977

(22) Filed: Nov. 6, 2025

(30) Foreign Application Priority Data
Nov. 8, 2024 (KR) 10-2024-0158170

(51) Int. Cl. C25F 5/00; H01M 10/54

(52) U.S. Cl. CPC C25F 5/00; H01M 10/54

(57) ABSTRACT

In a method for separating an electrode, an electrode including an electrode current collector and an electrode active material layer, together with a counter electrode electrically connected to the electrode are partially immersed in a conductive solution. An electrical signal is applied. The application of the electrical signal may improve separation efficiency. In addition, the reuse efficiency of the electrode active material may be improved.

### CROSS-REFERENCE TO RELATED APPLICATIONS

This application claims priority under 35 U.S.C. § 119 to Korean Patent Application No. 10-2024-0158170, filed on Nov. 8, 2024 in the Korean Intellectual Property Office (KIPO), the entire disclosures of which are incorporated by reference herein.

### BACKGROUND OF THE INVENTION

### 1. Field of the Invention

The disclosure of the present application relates to an electrode separation method and a separation system.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric vehicles.

A lithium secondary battery may include: an electrode assembly including a cathode, an anode, and a separation membrane; and an electrolyte that impregnates the electrode assembly. The lithium secondary battery may also include an outer case (e.g., a pouch) that accommodates the electrode assembly and the electrolyte. A lithium metal oxide may be used as a cathode active material of the cathode. The lithium metal oxide may contain a transition metal such as nickel, cobalt, or manganese.

Due to the manufacturing costs of the above-described expensive precious metals, environmental protection issues, and the like, electrode separation methods have been studied. For example, the cathode current collector and the cathode active material layer may be separated from the cathode, and metals may be recovered through acid treatment of the cathode active material layer. Although a sodium hydroxide solution may be used to separate the cathode current collector and the cathode active material layer, metals (e.g., aluminum) included in the cathode current collector may remain on the surface of the cathode active material during the separation process, and these remaining metals may act as impurities during the recycling of the cathode active material.

### SUMMARY OF THE INVENTION

An object of the present disclosure is to provide an electrode separation method with improved efficiency.

Another object of the present disclosure is to provide an electrode separation system with improved efficiency.

In a method for separating an electrode according to embodiments of the present disclosure, an electrode including an electrode current collector and an electrode active material layer, and a counter electrode electrically connected to the electrode are partially immersed in a conductive solution. An electrical signal is applied.

According to some embodiments, the step of applying an electrical signal may include generating gas between the electrode current collector and the electrode active material layer.

According to some embodiments, the step of applying an electrical signal may include applying a direct current signal.

According to some embodiments, the step of applying an electrical signal may include applying an electrical signal so that the current value ranges from 0.01 A to 8 A.

According to some embodiments, the conductive solution may include an aqueous solvent.

According to some embodiments, the conductive solution may include a transition metal.

According to some embodiments, the transition metal may include at least one of nickel, cobalt and manganese.

According to some embodiments, the transition metal may include nickel, and the molar amount of nickel based on the total molar amount of the transition metals may be 0.2 to 0.9.

According to some embodiments, the concentration of the transition metal in the conductive solution may be 0.2 to 1.5 M.

According to some embodiments, the electrode may be moved via a movable part.

According to some embodiments, the electrode and the counter electrode may be separated by a separation part.

According to some embodiments, the electrode may be obtained by heat-treating a waste lithium secondary battery at 500° C. or lower.

According to some embodiments, the counter electrode may have an electrical conductivity of 1 S/m or more.

A system for separating an electrode according to some embodiments of the present disclosure includes: an electrode part including an electrode current collector and an electrode active material layer, a counter electrode part electrically connected to the electrode part; a reaction part configured to partially immerse the electrode part and the counter electrode part in a conductive solution; and an electrical signal application unit configured to apply an electrical signal.

According to the electrode separation method of the embodiments of the present disclosure, an electrode including an electrode current collector and an electrode active material layer, and a counter electrode electrically connected to the electrode, are partially immersed in a conductive solution, and an electrical signal is applied thereto. This allows the electrode to be separated in a short time and with high energy efficiency.

In some embodiments, a direct current signal may be applied as the electrical signal. Accordingly, the amount of metal dissolved from the electrode current collector may be decreased, thereby reducing the content of impurities in the recovered electrode active material when the recovered electrode active material is recycled.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic flowchart illustrating an electrode separation method according to some embodiments; and

FIGS. 2 to 4 are schematic views illustrating an electrode separation system according to some embodiments.

### DETAILED DESCRIPTION OF THE INVENTION

Embodiments of the present disclosure provide a method for separating an electrode including an electrode current collector and an electrode active material layer. In addition, the present disclosure provides a system for separating the electrode.

The drawings and embodiments attached to this specification serve to further facilitate understanding of the technical concept disclosed herein, and therefore, the technical spirit of the present disclosure should not be interpreted as being limited to the matters illustrated and described in such drawings and embodiments.

FIG. 1 is a schematic flowchart illustrating the processes of an electrode separation method according to some embodiments.

Referring to FIG. 1, an electrode including an electrode current collector and an electrode active material layer, and a counter electrode, may be prepared (e.g., step S10).

The electrode includes a cathode and/or an anode. For example, the electrode may be either a cathode or an anode.

The counter electrode may have a polarity electrically opposite to that of the electrode. For example, when the electrode is a cathode, the counter electrode may be an anode. For example, when the electrode is an anode, the counter electrode may be a cathode.

According to some embodiments, the electrode may be prepared from a waste lithium secondary battery.

The lithium secondary battery may include an electrode assembly including a cathode, an anode, and a separation membrane interposed between the cathode and the anode. For example, the lithium secondary battery may include an NCM battery including nickel, manganese and cobalt; an NCMA battery including nickel, cobalt, manganese and aluminum; an LFP battery including lithium, iron and phosphoric acid; or an LCO battery including lithium and cobalt.

According to some embodiments, the electrode current collector and the electrode active material layer may be in direct contact with each other. For example, the electrode may include an electrode current collector and an electrode active material layer formed on one or both surfaces of the electrode current collector.

According to some embodiments, the electrode may be a cathode. For example, the electrode may include a cathode current collector and a cathode active material layer formed on at least one surface of the cathode current collector.

The cathode current collector may include stainless steel, nickel, aluminum, titanium, or an alloy thereof. The cathode current collector may also include aluminum or stainless steel having a surface treated with carbon, nickel, titanium, or silver.

The cathode active material layer may include a cathode active material. The cathode active material layer may also include a conductive material and a binder.

The cathode active material may include a compound capable of reversibly intercalating and deintercalating lithium ions.

According to some embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 1 below.

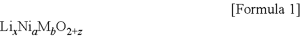

In Formula 1, x, a, b and z may satisfy 0.95≤x≤1.2, 0.6≤a≤0.99, 0.01≤b≥0.4, and −0.5≤z≤0.1. As described above, M may include Co, Mn and/or Al.

The chemical structure represented by Formula 1 indicates a bonding relationship between elements included in the layered structure or the crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing the introduction and substitution of additional elements.

In an embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form bonds, and it should be understood that this case is also included within the chemical structure range represented by Formula 1.

The auxiliary element may include, for example, at least one selected from the group consisting of Na, Mg Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may also act, for example, as an auxiliary active element which contributes to the capacity/output activity of the cathode active material together with Co or Mn, such as Al.

In some embodiments, the cathode active material may include a lithium cobalt oxide-based active material, a lithium manganese oxide-based active material, a lithium nickel oxide-based active material, or a lithium iron phosphate (LFP)-based active material (e.g, LiFePO₄).

In some embodiments, the cathode active material may include a manganese (Mn)-rich active material, or a lithium (Li)-rich layered oxide (LLO)/over-lithiated oxide (OLO)-based active material, and a cobalt (Co)-less active material.

The binder may include polyvinylidene fluoride (PVDF), poly(vinylidene fluoride-co-hexafluoropropylene), polyacrylonitrile, polymethyl methacrylate, acrylonitrile butadiene rubber (NBR), poly (butadiene) rubber (BR), styrene-butadiene rubber (SBR) and the like. In an embodiment, a PVDF-based binder may be used as the cathode binder.

The conductive material may be added to the cathode active material layer to enhance the conductivity thereof and/or the mobility of lithium ions or electrons. For example, the conductive material may include carbon-based conductive materials such as graphite, carbon black, acetylene black, Ketjen black, graphene, carbon nanotubes, vapor-grown carbon fibers (VGCFs), and carbon fibers, and/or metal-based conductive materials, including perovskite materials, such as tin, tin oxide, titanium oxide, LaSrCoO₃, and LaSrMnO₃, but is not limited thereto.

According to some embodiments, the cathode may be a cathode separated from a waste lithium secondary battery. For example, the cathode may be obtained by physically removing the separation membrane and the anode from the waste lithium secondary battery.

According to some embodiments, the cathode may include heat-treated waste cathode scrap.

According to some embodiments, the cathode may be prepared by heat-treating a waste lithium secondary battery at 500° C. or lower. For example, the separation membrane and the anode of the waste lithium secondary battery may be separated and heat-treated at a temperature of 500° C. or lower, 300° C. to 500° C., or 350° C. to 450° C. to remove the binder and conductive material included in the cathode. The heat-treated cathode may be substantially free of binder.

By using a heat-treated cathode, the cathode current collector and the cathode active material layer may be separated more quickly upon application of the electrical signal described below.

In some embodiments, the electrode may be an anode. For example, the anode may be an anode separated from a waste lithium secondary battery. In this case, the counter electrode may be a cathode.

The anode may include an anode current collector (e.g., copper (Cu) and an anode active material layer.

For example, as the anode active material, any active material known in the art may be used, so long as it is capable of absorbing and desorbing lithium ions. For example, the anode active material may include carbon-based materials such as crystalline carbon, amorphous carbon, carbon composites, or carbon fibers, and the like.; a lithium alloy; a silicon (Si)-based compound; or a tin (Sn)-containing material.

According to some embodiments, the electrode may be a working electrode. For example, the electrode active material included in the electrode active material layer may act as a catalyst to induce an electrochemical reaction on the electrode.

According to some embodiments, the counter electrode may include a material that is electrically connected to the electrode and capable of forming a current flow. For example, the counter electrode may include nickel, aluminum, copper, silver, silicon, oxides thereof, alloys thereof, and the like.

According to some embodiments, the counter electrode may include a nickel metal electrode or a lithium metal electrode.

According to some embodiments, the counter electrode may have an electrical conductivity of 1 S/m or more.

In some embodiments, the counter electrode may have an electrical conductivity of 2 S/m or more, 4 S/m or more, 5 S/m or more, 7 S/m or more, or 10 S/m or more.

The upper limit of the electrical conductivity of the counter electrode is not limited, but may be, for example, 100 S/m or less, 90 S/m or less, 85 S/m or less, or 80 S/m or less.

The electrical conductivity indicates the degree of current transmission of the electrode or counter electrode, and may correspond to the reciprocal of the electrical resistivity.

Within the above range, an electrochemical reaction may be more easily induced between the electrode current collector and the electrode active material layer with relatively low energy.

According to some embodiments, the counter electrode may be an electrode serving as a counterpart to the electrode (counter electrode). For example, current may be transmitted to the working electrode (the electrode) to more easily induce an electrochemical reaction on the working electrode.

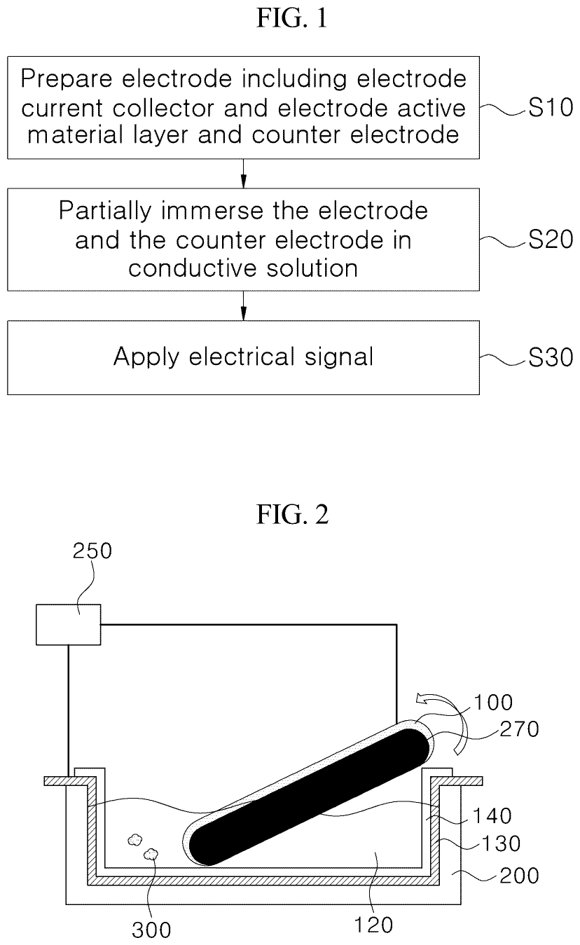

FIGS. 2 to 4 are schematic views illustrating an electrode separation system according to some embodiments.

Referring to FIGS. 1 to 4, an electrode 100 and a counter electrode 130 may be partially immersed in a conductive solution 120 (e.g., step S20).

As the electrode 100 and the counter electrode 130 are partially immersed in the conductive solution 120, the electrode current collector and the electrode active material layer may be efficiently separated under the control of the electrical signal described below, thereby achieving a high recovery rate of the electrode active material.

For example, if at least one of the electrode 100 and the counter electrode 130 is entirely immersed in the conductive solution 120, the electrochemical reaction may not be properly controlled, causing metal from the electrode current collector to dissolve into the conductive solution 120, so that a large amount of impurities may be included in the electrode active material layer, or metal from the electrode active material layer may dissolve into the conductive solution 120, thereby further reducing the recovery rate of the electrode active material. In addition, energy consumption for the electrochemical reaction may increase, further reducing the electrode separation efficiency.

According to some embodiments, up to 99.9% of the total area of the electrode 100 may be immersed in the conductive solution 120.

For example, the electrode 100 may be electrically connected to an electrical signal application unit 250 described below, and the remaining area, excluding a portion configured to prevent short-circuiting, may be immersed in the conductive solution 120.

In some embodiments, 10% to 99.9%, 15% to 99%, 20% to 97%, or 25% to 95% of the total area of the electrode 100 may be immersed in the conductive solution 120. Within this range, the current required for separation may decrease, and the separation time may decrease, thereby further improving the electrode separation efficiency.

According to some embodiments, the conductive solution 120 may include a material capable of conducting current between the electrode 100 and the counter electrode 130.

According to some embodiments, the conductive solution 120 may include a solvent and an electrolyte.

Examples of the solvent may include an aqueous solvent including water, an organic solvent including propylene carbonate (PC), ethylene carbonate (EC), butylene carbonate, diethyl carbonate (DEC), dimethyl carbonate (DMC), ethylmethyl carbonate (EMC), methylpropyl carbonate, ethylpropyl carbonate, dipropyl carbonate, and the like. These solvents may be used alone or in combination of two or more.

Examples of the electrolyte may include metal salts having cations such as lithium, nickel, manganese, cobalt, aluminum, or iron. Examples of the metal salts may include nitrates, sulfates, carbonates, phosphates, acetates, halides, and the like.

According to some embodiments, the conductive solution 120 may include an aqueous solvent.

The aqueous solvent may refer to a solvent including water (H₂O) as a main component, such as distilled water or ultrapure water. For example, the aqueous solvent may refer to a solvent in which the water content is at least 90% of the total weight of the aqueous solvent. The aqueous solvent may also include a portion of organic solvents such as methanol, ethanol, isopropanol, acetone, tetrahydrofuran, or dimethyl sulfoxide.

In an embodiment, the conductive solution 120 may include water.

The aqueous solvent may generate gas upon application of an electrical signal, as described below, thereby facilitating the separation of the electrode current collector and the electrode active material layer.

According to some embodiments, the conductive solution 120 may include a transition metal.

For example, the conductive solution 120 may include a salt of a transition metal. Examples of the transition metal may include nickel, manganese, or cobalt, which are metals included in the above-described cathode active material.

The conductive solution 120 including a transition metal may promote the catalytic function of the electrode active material, thereby accelerating the separation of the electrode current collector and the electrode active material layer.

According to some embodiments, the transition metal may include one or more of nickel, cobalt and manganese.

In some embodiments, the transition metal may include nickel, cobalt and manganese.

Nickel, cobalt, and manganese may function as catalysts together with the electrode active material, and may be removed together with the electrode active material, thereby eliminating the need for a separate process for impurity removal.

In some embodiments, the molar amount of nickel based on the total molar amount of the transition metals may be 0.2 to 0.9, 0.25 to 0.85, 0.28 to 0.80, or 0.3 to 0.75.

Within the above range, the oxygen evolution reaction may be promoted, thereby further facilitating the physical separation of the electrode current collector and the electrode active material layer.

In some embodiments, the molar amount of cobalt based on the total molar amount of the transition metals may be 0.05 to 0.45, 0.10 to 0.43, 0.15 to 0.42, or 0.20 to 0.4.

In some embodiments, the molar amount of manganese based on the total molar amount of the transition metals may be 0.05 to 0.45, 0.10 to 0.43, 0.15 to 0.42, or 0.20 to 0.4.

In some embodiments, the concentration of the transition metal in the conductive solution 120 may be 0.2 M to 1.5 M, 0.3 M to 1.3 M, 0.4 M to 1.1 M, or 0.5 M to 1.0 M.

Within the above range, metal precipitation on the electrode current collector due to the transition metals may be suppressed. In addition, the increase in pH of the conductive solution 120 may be suppressed, thereby further inhibiting an increase in the oxygen evolution potential and further suppressing a decrease in the transition metal recovery rate.

For example, if the concentration of the transition metals exceeds the above range, the solubility of the metal (e.g., aluminum) detached from the electrode current collector in the conductive solution 120 may increase. Accordingly, the content of impurities included in the separated electrode active material may increase.

In some embodiments, the conductive solution 120 may include one or more of aluminum and iron. For example, when the cathode active material includes aluminum or iron, the conductive solution 120 may further include a metal salt containing aluminum or iron.

According to some embodiments, the temperature of the conductive solution 120 may be maintained in the range of 0° C. to 80° C. For example, the temperature may be maintained even when an electrical signal, as described below, is applied.

Within the above temperature range, solvent molecule migration in the conductive solution may be accelerated, thereby promoting gas generation upon application of the electrical signal described below, thereby further facilitating electrode separation.

According to some embodiments, the electrode 100 and the counter electrode 130 may be separated by a separation part 140.

For example, the separation part 140 may be disposed on the counter electrode 130, a movable part 270 may be placed on the separation part 140, and the electrode 100 may be disposed on the movable part 270 (see FIG. 2).

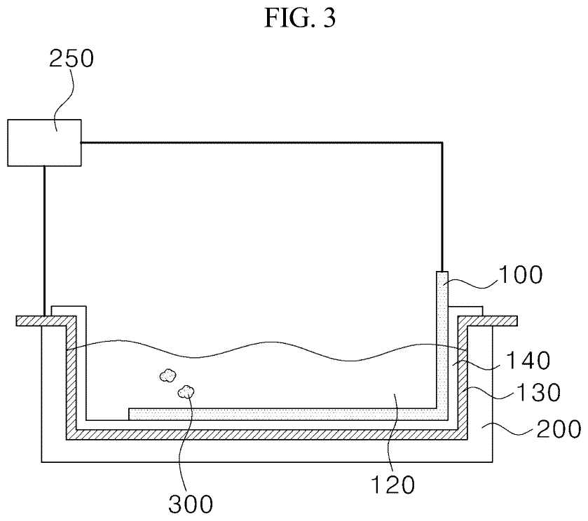

Alternatively, the separation part 140 may be disposed on the counter electrode 130, and the electrode 100 may be disposed on the separation part 140 (see FIG. 3).

The electrode 100 and the counter electrode 130 may be physically separated by the separation part 140.

For example, the separation part 140 on the counter electrode 130 may be formed on a portion of the counter electrode 130 to block physical contact between the counter electrode 130 and the electrode 100, thereby preventing short-circuiting. For example, the separation part 140 may be formed on a portion of the counter electrode 130 so that another portion of the counter electrode 130 is exposed to the conductive solution 120, thereby allowing current flow. The electrode 100 and the counter electrode 130 may have various shapes in consideration of physical separation by the separation part 140, movement by the movable part 270, and an increased reaction area.

According to some embodiments, an ion-permeable material may be used as the separation part 140.

For example, polypropylene, polyethylene, polycarbonate, polyimide, polyurethane, polyvinylidene fluoride, polyvinylidene fluoride-hexafluoropropylene copolymer, polyethylene oxide, an ion exchange membrane, glass fiber, or a ceramic separator may be used as the material for the separation part.

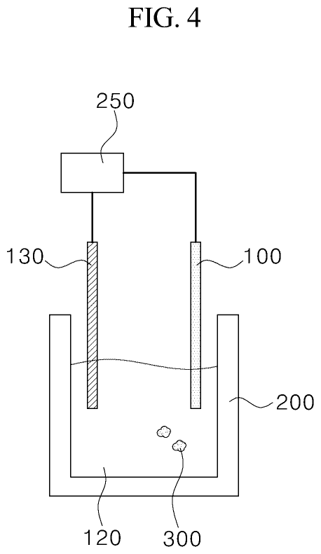

In some embodiments, the electrode 100 and the counter electrode 130 may be partially immersed in the conductive solution without using the separation part 140 (see FIG. 4). In this case, the electrode 100 and the counter electrode 130 may be physically separated from each other.

According to some embodiments, the electrode 100 may be moved via the movable part 270. For example, the electrode 100 may be moved while an electrical signal is applied as described below.

The method for moving the electrode 100 is not limited. For example, the electrode 100 may be placed on a circular roll and the circular roll may be rotated at a constant speed to move the electrode 100 in a direction that increases the area immersed in the conductive solution 120.

Movement of the electrode 100 may be achieved by the movable part 270, allowing a relatively small area of the electrode 100 to be immersed in the conductive solution 120 at the beginning of the reaction, thereby further improving the efficiency of the electrochemical reaction.

According to some embodiments, an electrical signal may be applied through the electrical signal application unit 250 (e.g., step S30).

According to some embodiments, the electrode 100 and the counter electrode 130 may be connected to the electrical signal application unit 250. The electrical signal application unit 250 may control the current flowing through the electrode 100, the counter electrode 130 and the conductive solution 120.

For example, an electrical signal may be applied through the electrical signal application unit 250 including a power supply, a current generator, a pulse generator, and the like.

By controlling the current through the electrical signal application unit 250, electrode separation efficiency may be further improved, including shortening the electrode separation time, reducing energy consumption, and reducing impurities.

According to some embodiments, gas may be generated between the electrode current collector and the electrode active material layer by applying an electrical signal.

The generation of gas may separate the electrode current collector and the electrode active material layer. For example, the generation of gas may form and expand a space between the electrode current collector and the electrode active material layer, thereby separating the electrode current collector and the electrode active material layer.

For example, the conductive solution 120 may include an aqueous solvent, and water in the aqueous solvent may be electrochemically decomposed to generate oxygen. For example, water may be decomposed according to Reaction Scheme 1 below.

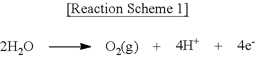

The transition metal included in the electrode active material layer or the transition metal included in the conductive solution 120 may act as a catalyst to further promote the oxygen evolution reaction.

In some embodiments, the gas may include oxygen. The promotion of the oxygen evolution reaction may further accelerate the separation of the electrode current collector and the electrode active material layer.

According to some embodiments, the electrical signal may include a direct current signal.

By applying a direct current signal, a current within a predetermined range may be stably maintained, thereby promoting gas generation with relatively low energy. In addition, the electrode may be separated while suppressing the dissolution of metals from the electrode current collector and the electrode active material layer.

For example, when a pulse signal having large voltage fluctuations is applied, metals from the electrode current collector may dissolve into the conductive solution 120, thereby further reducing the recovery rate of the electrode active material.

According to some embodiments, the electrical signal may be applied so that the current value ranges from 0.01 A to 8 A.

In some embodiments, the electrical signal may be applied so that the current value ranges from 0.01 A to 7 A, 0.05 A to 6.5 A, 0.07 A to 6 A, 0.09 A to 5.5 A, or 0.1 A to 5 A.

Within the above range, metal dissolution from the electrode current collector or the electrode active material layer may be suppressed, thereby reducing impurities and further improving the recovery efficiency of the electrode active material.

According to some embodiments, the electrode active material 300 may be precipitated in the conductive solution 120.

For example, the electrode active material 300 may be separated from the electrode active material layer along with the separation of the electrode current collector and the electrode active material layer, and the electrode active material 300 may act as a catalyst for gas generation and be precipitated.

According to some embodiments, the electrode active material 300 may be recovered.

For example, the electrode active material 300 that is insoluble in the conductive solution 120 may be collected and washed to obtain the electrode active material. By separating the electrode active material through the application of an electrical signal, an electrode active material with low impurity content may be obtained with a higher recovery rate.

According to some embodiments, the recovery rate of the electrode active material 300 may be 80% or more, 85% or more, 87% or more, 88% or more, 89% or more, or 90% or more. The upper limit of the recovery rate of the electrode active material 300 is not limited, but may be, for example, 99.9% or less, or 99.5% or less.

The recovery rate may be calculated according to Equation 1 below.

$$Recovery rate = 1 - ( Content of electrode active material remaining \\ on the electrode current collector after separation of \\ the electrode active material layer and the electrode \\ current collector / Content of electrode active material \\ included in the electrode before separation ) \times 100 \qquad [ Equation 1 ]$$

The time and energy required for electrode separation may vary with the size of the electrode 100, the immersion area of the electrode 100, the current intensity, and the volume of the conductive solution. However, by applying an electrical signal, the required time and energy can be reduced, thereby enabling efficient electrode separation.

In some embodiments, the electrode 100 and the counter electrode 130 may not be connected to the electrical signal application unit 250. For example, the electrode 100 and the counter electrode 130 may be connected to each other via a wire and partially immersed in the conductive solution 120 to form a current, without being directly connected to the unit 250.

An electrode separation system according to some embodiments includes an electrode part including an electrode current collector and an electrode active material layer, a counter electrode part electrically connected to the electrode part, a reaction part 200 configured to partially immerse the electrode part and the counter electrode part in a conductive solution, and an electrical signal application unit configured to apply an electrical signal.

The electrode part and the counter electrode part may correspond to the electrode and the counter electrode described in the above embodiments.

The reaction part 200 may include a reactor containing a conductive solution. For example, the conductive solution may be introduced into the reactor, and the electrode part and the counter electrode part may be partially immersed in the conductive solution.

The conductive solution and the electrical signal application unit may be as described in the above embodiments.

Hereinafter, examples are presented to aid in understanding the present disclosure; however, these examples are provided merely for illustrative purposes and are not intended to limit the scope of the appended claims. It will be apparent to those skilled in the art that various modifications and changes may be made within the scope and spirit of the present disclosure, and such modifications and changes shall also fall within the scope of the appended claims.

### Example 1

A waste cathode was heat-treated at 400° C. in an air atmosphere to obtain waste cathode scrap including a cathode active material layer containing nickel, cobalt and manganese, and a cathode current collector containing aluminum.

Nickel sulfate (NiSO₄), cobalt sulfate (CoSO₄), and manganese sulfate (MnSO₄) were mixed at a molar ratio of 1:1:1, and water was added to prepare a conductive solution (200 mL, 1 M). The conductive solution was introduced into a reactor, and nickel foil was immersed in the conductive solution as a counter electrode. Glass fiber was stacked to partially cover the nickel foil, a circular roll was placed on the glass fiber, and the waste cathode scrap was placed on the circular roll.

After electrically connecting the nickel foil, the waste cathode scrap, and the electrical signal application unit, an electrical signal was applied to separate the cathode active material layer from the cathode current collector. The electrical signal was applied until the applied current dropped below 0.1 A. In addition, the cathode active material was obtained by washing the precipitate of the conductive solution.

### Examples 2 to 11

The cathode active material layer and the cathode current collector were separated from the waste cathode scrap to obtain the cathode active material in the same manner as in Example 1, except that the conductive solution and the electrical signal were modified as shown in Table 1. In Table 1, the electrical pulses were applied as 10 V (20 s)/rest (10 s)/−10 V (20 s).

TABLE 1

| | Conductive solution | | |
|---|---|---|---|
| Classification | Composition | Concentration | Electrical signal |
| Example 1 | Ni + Co + Mn (1:1:1) sulfate | 1M | 0.1 A (D.C) |
| Example 2 | Ni + Co + Mn (1:1:1) sulfate | 0.5M | 0.1 A (D.C) |
| Example 3 | Ni + Co + Mn (1:1:1) sulfate | 2M | 0.1 A (D.C) |
| Example 4 | Na₂SO₄ | 1M | 0.1 A (D.C) |
| Example 5 | Na₂SO₄ | 0.5M | 0.1 A (D.C) |
| Example 6 | Ni + Co + Mn (1:1:1) sulfate | 1M | 10 V pulse |
| Example 7 | Na₂SO₄ | 1M | 10 V pulse |
| Example 8 | Ni + Co + Mn (2:1:1) sulfate | 1M | 0.1 A (D.C) |
| Example 9 | Ni + Co + Mn (4:1:1) sulfate | 1M | 0.1 A (D.C) |
| Example 10 | Ni + Co + Mn (1:1:1) sulfate | 1M | 5 A (D.C) |
| Example 11 | Ni + Co + Mn (1:1:1) sulfate | 1M | 10 A (D.C) |

### Comparative Example

A waste cathode scrap was prepared in the same manner as in Example 1.

The waste cathode scrap was immersed and stirred in a 2 M aqueous sodium hydroxide (NaOH) solution at 50° C., maintained for 3 hours, and the cathode current collector and the cathode active material layer were separated. The cathode current collector and the cathode active material layer were washed with water to obtain the cathode active material.

### Experimental Example

### (1) Analysis of Separation Time

In the examples, the separation time between the cathode current collector and the cathode active material layer was measured. The separation time was defined as the time when the cathode current collector and the cathode active material layer were physically separated and the applied electrical signal could no longer maintain 0.1 A.

In the cathode separation according to the comparative example, a gap between the cathode current collector and the cathode active material layer appeared only after at least 1 hour.

### (2) Analysis of Aluminum Elution

In the cathode separation according to the examples, the aluminum content in the conductive solution was measured. Additionally, in the cathode separation according to the comparative example, the aluminum content in the sodium hydroxide aqueous solution was measured. The aluminum content was measured using inductively coupled plasma-optical emission spectrometry (ICP-OES).

### (3) Analysis of Recovery Rate

The recovery rates of the cathode active material in the examples and comparative examples were measured according to Equation 1 below. The cathode active material content was measured using ICP-OES.

$$Recovery rate = 1 - ( Content of cathode active material remaining \\ on the cathode current collector after separation of \\ the cathode active material layer and cathode \\ current collector / Content of cathode active material \\ included in the cathode before separation ) \times 100 \qquad [ Equation 1 ]$$

### (4) Analysis of Energy Efficiency

During cathode separation according to the examples, the energy consumed by the electrical signal application unit was measured, and the energy consumption per unit area was calculated.

The results of the analysis of separation time, aluminum elution amount, recovery rate, and energy efficiency are shown in Table 2 below.

TABLE 2

| | | | | Energy |
|---|---|---|---|---|
| | Separation | Aluminum elution | | consumption |
| Classification | time (s) | amount (ppm) | Recovery rate (%) | (J/cm²) |
| Example 1 | 50 | 1.6 | 95.0 | 6.25 |
| Example 2 | 46 | 0.3 | 95.1 | 5.75 |
| Example 3 | 42 | 3.8 | 86.8 | 5.93 |
| Example 4 | 85 | 0.2 | 90.5 | 10.63 |
| Example 5 | 91 | 0.4 | 90.3 | 11.38 |
| Example 6 | 90 | 2.0 | 85.3 | 13.50 |
| Example 7 | 20 | 3.1 | 79.8 | 4.25 |
| Example 8 | 53 | 0.4 | 94.7 | 6.34 |
| Example 9 | 51 | 0.3 | 94.5 | 6.31 |
| Example 10 | 25 | 1.7 | 92.8 | 6.30 |
| Example 11 | 20 | 19.5 | 80.5 | 5.51 |
| Comparative | >3,600 | 11.3 | 95.3 | — |
| Example | | | | |

Referring to Table 2, in the examples, the electrodes were separated with a short separation time, low aluminum elution, high cathode recovery rate, and low energy consumption.

In the comparative example, the electrode separation time was significantly longer, and the aluminum elution in the solution was high.

In Example 3, which used a conductive solution with a relatively high transition metal concentration, the aluminum elution increased, and the recovery rate relatively decreased.

In Examples 4 and 5, which used sodium sulfate, the separation time and energy consumption relatively increased.

In Example 6, which applied an electric pulse signal, the separation time and energy consumption relatively increased.

In Example 7, which used sodium sulfate and applied an electric pulse signal, the aluminum elution increased, and the recovery rate of the cathode active material decreased.

In Example 11, which applied an electrical signal at a relatively high current, the aluminum elution increased, and the recovery rate of the cathode active material decreased.

What is claimed is:

1. A method for separating an electrode, comprising:
partially immersing an electrode including an electrode current collector and an electrode active material layer, and a counter electrode electrically connected to the electrode, in a conductive solution; and
applying an electrical signal.

2. The method for separating an electrode according to claim 1, wherein the step of applying an electrical signal comprises generating gas between the electrode current collector and the electrode active material layer.

3. The method for separating an electrode according to claim 1, wherein the step of applying an electrical signal comprises applying a direct current signal.

4. The method for separating an electrode according to claim 1, wherein the step of applying an electrical signal comprises applying an electrical signal so that the current value ranges from 0.01 A to 8 A.

5. The method for separating an electrode according to claim 1, wherein the conductive solution comprises an aqueous solvent.

6. The method for separating an electrode according to claim 1, wherein the conductive solution comprises a transition metal.

7. The method for separating an electrode according to claim 6, wherein the transition metal comprises at least one of nickel, cobalt and manganese.

8. The method for separating an electrode according to claim 6, wherein the transition metal comprises nickel, and the molar amount of nickel based on the total molar amount of the transition metals is 0.2 to 0.9.

9. The method for separating an electrode according to claim 6, wherein the concentration of the transition metal in the conductive solution is 0.2 to 1.5 M.

10. The method for separating an electrode according to claim 1, the electrode is moved via a movable part.

11. The method for separating an electrode according to claim 10, wherein the electrode and the counter electrode are separated by a separation part.

12. The method for separating an electrode according to claim 1, wherein the electrode is obtained by heat-treating a waste lithium secondary battery at 500° C. or lower.

13. The method for separating an electrode according to claim 1, wherein the counter electrode has an electrical conductivity of 1 S/m or more.

14. A system for separating an electrode, comprising
an electrode part including an electrode current collector and an electrode active material layer,
a counter electrode part electrically connected to the electrode part,
a reaction part configured to partially immerse the electrode part and the counter electrode part in a conductive solution; and
an electrical signal application unit configured to apply an electrical signal.
